(19) United States
(12) Patent Application Publication
(10) Pub. No.: US 2026/0261423 A1
(43) Pub. Date: Sep. 3, 2026

(54) METHOD, PLATFORM, SYSTEM AND APPARATUS OF PROCESSING BLOCK-CHAIN DATA, AND ELECTRONIC DEVICE

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Xiao Chu, Beijing (CN); Ning Zhang, Beijing (CN); Yu Miao, Beijing (CN); Xueda Bian, Beijing (CN); Xinyin Wu, Beijing (CN); Honglei Zhang, Beijing (CN)

(21) Appl. No.: 18/995,735

(22) PCT Filed: Mar. 31, 2023
(86) PCT No.: PCT/CN2023/085649

§ 371 Date: Jan. 16, 2025

(51) Int. Cl. H04L 9/32; H04L 9/00; H04L 9/08; H04L 9/30

(52) U.S. Cl. CPC H04L 9/3236; H04L 9/0825; H04L 9/30; H04L 9/3247; H04L 9/50

(57) ABSTRACT

A method, platform, system and apparatus of processing block-chain data, an electronic device, and a storage medium are provided. The method includes: acquiring, in response to receiving a data processing request from a first client device, at least one first block-chain data from a first block-chain network based on an object identification information carried by the data processing request; authenticating the first client device based on an encrypted verification information carried by the data processing request; and sending the at least one first block-chain data to the first client device in response to determining that an authentication of the first client device is completed, so that the first client device decrypts the at least one first block-chain data to obtain at least one second block-chain data by using at least one block body private key respectively corresponding to the at least one first block-chain data.

### CROSS-REFERENCE TO RELATED APPLICATION(S)

This application is a Section 371 National Stage Application of International Application No. PCT/CN2023/085649, filed on Mar. 31, 2023, entitled “METHOD, PLATFORM, SYSTEM AND APPARATUS OF PROCESSING BLOCK-CHAIN DATA, AND ELECTRONIC DEVICE”, the content of which is incorporated herein by reference in its entirety.

### TECHNICAL FIELD

The present disclosure relates to a field of a block-chain technology, and in particular to a method, platform, system and apparatus of processing block-chain data, an electronic device, and a storage medium.

### BACKGROUND

Block-chain is a linked data structure combined by sequentially connecting data blocks in a chronological order, which is a tamper-proof and unforgeable distributed ledger ensured by cryptographic methods. On-chain data of a block-chain network is a data island, and different block-chains may not be interconnected, which hinders a further development of a data application ecosystem between different block-chains. In order to improve a utilization efficiency of block-chain data, it is possible to achieve data sharing between block-chains using a cross-chain data processing method.

### SUMMARY

The present disclosure provides a method, platform, system and apparatus of processing block-chain data, an electronic device, and a storage medium.

According to an aspect of the present disclosure, a method of processing block-chain data is provided, including: acquiring, in response to receiving a data processing request from a first client device, at least one first block-chain data from a first block-chain network based on an object identification information carried by the data processing request; authenticating the first client device based on an encrypted verification information carried by the data processing request; and sending the at least one first block-chain data to the first client device in response to determining that an authentication of the first client device is completed, so that the first client device decrypts the at least one first block-chain data to obtain at least one second block-chain data by using at least one block body private key respectively corresponding to the at least one first block-chain data.

According to another aspect of the present disclosure, a platform of processing block-chain data is provided, including: a block-chain data source management module configured to acquire, in response to receiving a data processing request from a first client device, at least one first block-chain data from a first block-chain network based on an object identification information carried by the data processing request; a private key control module configured to authenticate the first client device based on an encrypted verification information carried by the data processing request; and a data processing module configured to send the at least one first block-chain data to the first client device in response to determining that an authentication of the first client device is completed, so that the first client device decrypts the at least one first block-chain data to obtain at least one second block-chain data by using at least one block body private key respectively corresponding to the at least one first block-chain data.

According to another aspect of the present disclosure, a system of processing block-chain data, including: a first client device, a first block-chain network, a platform of processing the block-chain data, and a distributed private key network; where the platform of processing the block-chain data is configured to: acquire, in response to receiving a data processing request from a first client device, at least one first block-chain data from a first block-chain network based on an object identification information carried by the data processing request; authenticate the first client device based on an encrypted verification information carried by the data processing request; and send the at least one first block-chain data to the first client device in response to determining that an authentication of the first client device is completed; and where the first client device is configured to: decrypt the at least one first block-chain data to obtain at least one second block-chain data by using at least one block body private key respectively corresponding to the at least one first block-chain data.

According to another aspect of the present disclosure, an apparatus of processing block-chain data is provided, including: a first acquisition module configured to acquire, in response to receiving a data processing request from a first client device, at least one first block-chain data from a first block-chain network based on an object identification information carried by the data processing request; an authentication module configured to authenticate the first client device based on an encrypted verification information carried by the data processing request; and a first sending module configured to send the at least one first block-chain data to the first client device in response to determining that an authentication of the first client device is completed, so that the first client device decrypts the at least one first block-chain data to obtain at least one second block-chain data by using at least one block body private key respectively corresponding to the at least one first block-chain data.

According to another aspect of the present disclosure, an electronic device is provided, including a memory and a processor, where the memory stores instructions executable by the processor, and the instructions are configured to, when executed by the processor, cause the processor to implement the method as described above.

According to another aspect of the present disclosure, a non-instantaneous computer-readable storage medium having computer instructions stored thereon is provided, where the computer instructions are configured to cause a computer to implement the method as described above.

According to another aspect of the present disclosure, a computer program product containing a computer program, where the computer program is configured to, when executed by a processor, cause the processor to implement the method as described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of solutions and do not constitute limitations to the present disclosure. In the accompanying drawings:

FIG. 1 schematically shows an exemplary system architecture to which a method of processing block-chain data may be applied according to embodiments of the present disclosure.

FIG. 2 schematically shows a flowchart of a method of processing block-chain data according to embodiments of the present disclosure.

FIG. 3 schematically shows a flowchart of a method of processing block-chain data according to other embodiments of the present disclosure.

FIG. 4 schematically shows a flowchart of a method of processing block-chain data according to still other embodiments of the present disclosure.

FIG. 5A schematically shows a schematic diagram of a method of asynchronously viewing block-chain data according to embodiments of the present disclosure.

FIG. 5B schematically shows a schematic diagram of a method of synchronously viewing block-chain data according to embodiments of the present disclosure.

FIG. 6 schematically shows a schematic diagram of a method of sharing block-chain data according to embodiments of the present disclosure.

FIG. 7 schematically shows a schematic diagram of a method of calling block-chain data according to embodiments of the present disclosure.

FIG. 8 schematically shows a schematic diagram of a platform of processing block-chain data according to embodiments of the present disclosure.

FIG. 9 schematically shows a schematic diagram of a system of processing block-chain data according to embodiments of the present disclosure.

FIG. 10 schematically shows a block diagram of an apparatus of processing block-chain data according to embodiments of the present disclosure.

FIG. 11 schematically shows a block diagram of an electronic device suitable for implementing a method of processing block-chain data according to embodiments of the present disclosure.

### DETAILED DESCRIPTION OF EMBODIMENTS

Embodiments of the present disclosure will be described below with reference to the accompanying drawings. However, it should be understood that those descriptions are just exemplary and are not intended to limit the scope of the present disclosure. In the following detailed description, for ease of interpretation, many specific details are set forth to provide a comprehensive understanding of embodiments of the present disclosure. However, it is clear that one or more embodiments may also be implemented without those specific details. In addition, in the following description, descriptions of well-known structures and technologies are omitted to avoid unnecessarily obscuring the concepts of the present disclosure.

The terms used herein are just for the purpose of describing specific embodiments and are not intended to limit the present disclosure. The terms “including”, “containing”, etc. used herein indicate the presence of the feature, step, operation and/or component, but do not exclude the presence or addition of one or more other features, steps, operations or components.

All terms used herein (including technical and scientific terms) have the meanings generally understood by those skilled in the art, unless otherwise defined. It should be noted that the terms used herein shall be interpreted to have meanings consistent with the context of this specification, and shall not be interpreted in an idealized or too rigid way.

In a case of using the expression similar to “at least one of A, B and C”, it should be explained according to the meaning of the expression generally understood by those skilled in the art (for example, “a system including at least one of A, B and C” should include but not be limited to a system including only A, a system including only B, a system including only C, a system including A and B, a system including A and C, a system including B and C, and/or a system including A, B and C). In a case of using the expression similar to “at least one of A, B or C”, it should be explained according to the meaning of the expression generally understood by those skilled in the art (for example, “a system including at least one of A, B or C” should include but not be limited to a system including only A, a system including only B, a system including only C, a system including A and B, a system including A and C, a system including B and C, and/or a system including A, B and C).

In technical solutions of the present disclosure, a collection, a storage, a use, a processing, a transmission, a provision, a disclosure, an application and other processing of data (including but not limited to user personal information) involved comply with provisions of relevant laws and regulations, take necessary security measures, and do not violate public order and good custom.

In the technical solutions of the present disclosure, the acquisition or collection of user personal information has been authorized or allowed by users.

It should be noted that operations shown in the flowcharts in embodiments of the present disclosure may be executed in a non-sequential manner or may be executed simultaneously, unless a sequence of execution of different operations or a sequence of execution of different operations in terms of technical implementation is clearly stated.

In order to meet needs of information development and business expansion, enterprises generally build business information systems, such as ERP (Enterprise Resource Planning), OA (Office Automation), CRM (Customer Relationship Management), etc. A business information system may standardize a business process, form a standardized business model, precipitate business data through a system database, and accumulate data assets for enterprises. Moreover, with a gradual attention of the public on data privacy issues, block-chain has gradually replaced system databases as a storage unit of a business information system due to its decentralization, tamper resistance, encrypted storage and other characteristics. However, on-chain data of a block-chain network is a data island, and different block-chains may not be interconnected and may not be utilized uniformly, which hinders a further development of a data application ecosystem between different block-chains.

Taking medical block-chain as an example, there are many problems in a construction of medical data. For example, various institutions may not quickly and conveniently share data; systems and software of hospitals are mostly developed and maintained through third-party software companies, those third-party companies in the market are mixed and have security vulnerabilities, but medical data has high privacy and high value; there are disputes over the ownership and access permissions of medical data. In a related art, medical data is generally stored directly on a block-chain, which greatly increases expenses of a block-chain network and makes throughput become a bottleneck that hinders technological development. Furthermore, there is also a problem of confusion in data ownership. Even a patient per se may not own all medical data, and storing medical data in hospitals may cause complicated data sharing procedures, which makes large-scale data sharing to be unrealistic.

In view of this, embodiments of the present disclosure provide a method of processing block-chain data. In response to a data processing request being received from a first client device, at least one first block-chain data is acquired from a first block-chain network based on an object identification information carried by the data processing request. The first client device is authenticated based on an encrypted verification information carried by the data processing request. The at least one first block-chain data is sent to the first client device in response to determining that an authentication of the first client device is completed, so that the first client device decrypts the at least one first block-chain data to obtain at least one second block-chain data by using at least one block body private key respectively corresponding to the at least one first block-chain data.

For sake of understanding, relevant concepts involved in embodiments of the present disclosure will be firstly explained below.

Block-chain is a solution that uses a block-chain data structure to verify and store data, uses a distributed node consensus algorithm to generate and update data, uses cryptography to ensure a security of data transmission and access, and uses a smart contract collective composed of automated script codes to maintain a reliable database. Therefore, the block-chain has basic characteristics such as openness, decentralization, information sharing, tamper resistance and traceability. The block-chain may use blocks to replace dependency on a central server.

A block may be a container data structure that aggregates data, which is contained in the block-chain. The block may include a block header and a block body. The block header may include a version, a timestamp, a parent block hash value, a random number, a difficulty coefficient, and a Merkle root. The timestamp may represent a time when the block was created. The parent block hash value may be used to reference a previous block. The block body may include transaction details, a transaction counter, and a block size.

A smart contract is executable code stored in a block-chain. An execution condition of the smart contract and a service processing logic, i.e., a condition under which the smart contract is launched and how a received service processing request is processed after the smart contract is launched, are determined in the executable code. After being stored on the block-chain, the smart contract is difficult to edit or modify. For example, an execution of the smart contract may be triggered according to an event. For example, the execution of the smart contract may be recorded as a transaction on the block-chain and recorded on the block-chain.

According to a network scope, the block-chain may be divided into a public block-chain, a private block-chain, a consortium block-chain, and a hybrid block-chain. The consortium block-chain refers to a block-chain jointly participated in and managed by several institutions. Each institution may run at least one block-chain node. Data of the consortium block-chain may only be read, written and traded by institutions in the consortium block-chain system, and an initiation of identity management system, transactions or proposals based on PKI (Public Key Infrastructure) may be achieved through digital certificates, so as to reach a consensus through a joint signature and verification of the participants. In embodiments of the present disclosure, the type of block-chain may be determined according to actual service needs and is not limited here. For example, the block-chain system may be a consortium block-chain.

The block-chain system may include a plurality of block-chain nodes, which communicate through P2P (Peer to Peer). The block-chain node may be either a client or a server. That is, the block-chain node may not only request services of other block-chain nodes, but also provide services for other block-chain nodes or external applications.

FIG. 1 schematically shows an exemplary system architecture to which a method of processing block-chain data may be applied according to embodiments of the present disclosure. It should be noted that FIG. 1 is just an example of a system architecture to which embodiments of the present disclosure may be applied, so as to help those skilled in the art to understand the technical content of the present disclosure. It does not mean that embodiments of the present disclosure may not be applied to other devices, systems, environments or scenes.

As shown in FIG. 1, a system architecture 100 according to such embodiments may include a terminal device 101, a server 102, and a block-chain system 103.

The terminal device 101 may be various electronic devices having a display screen, including but not limited to a smart phone, a tablet computer, a laptop computer, and a desktop computer, etc.

The server 102 may be various types of servers providing various services. For example, the server may be a cloud server, also known as a cloud computing server or a cloud host, which is a host product in a cloud computing service system to solve shortcomings of difficult management and weak service scalability existing in a traditional physical host and VPS (Virtual Private Server) service. The server may also be an edge server. The server may also be a server of a distributed system or a server combined with a block-chain.

The block-chain network 103 may include a plurality of block-chain nodes, each of which may be a client device or a server.

Communication between the server 102 and the terminal device 101 or between the server 102 and various block-chain nodes of the block-chain network 103 may be performed through a network. The network may include various connection types, such as wired and/or wireless communication links.

It should be noted that the method of processing the block-chain data provided in embodiments of the present disclosure may generally be performed by the server 102. Accordingly, an apparatus of processing block-chain data provided in embodiments of the present disclosure may also be arranged in the server 102.

For example, an input operation, a selection operation and other operations may be performed by a user in a client application of the terminal device 101. The terminal device 101 may generate a data processing request based on the input operation, the selection operation and other operations, and send the data processing request to the server 102. In response to receiving the data processing request from the terminal device 101, the server 102 may acquire first block-chain data from the block-chain network 103 based on an object identification information carried by the data processing request. Furthermore, the server 102 may perform authenticating the terminal device 101 based on an encrypted verification information carried by the data processing request. When it is determined that an authentication of the terminal device 101 is completed, the first block-chain data is returned to the terminal device 101. The terminal device 101 may decrypt the first block-chain data to obtain second block-chain data by using a block body private key corresponding to the first block-chain data.

It should be understood that the number of terminal device, server and block-chain network in FIG. 1 is just schematic. According to implementation needs, any number of terminal device, server and block-chain network may be provided.

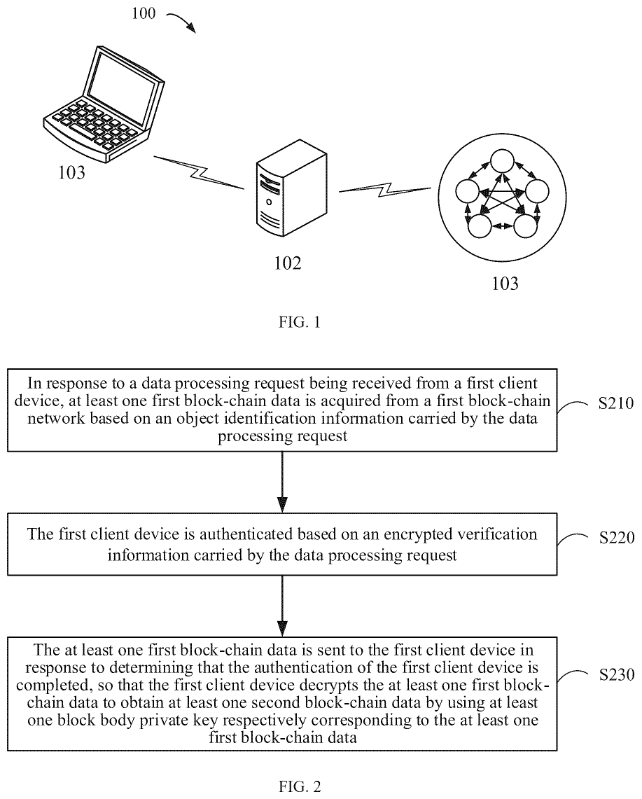

FIG. 2 schematically shows a flowchart of a method of processing block-chain data according to embodiments of the present disclosure.

As shown in FIG. 2, a method 200 includes operations S210 to S230.

In operation S210, in response to a data processing request being received from a first client device, at least one first block-chain data is acquired from a first block-chain network based on an object identification information carried by the data processing request.

In operation S220, the first client device is authenticated based on an encrypted verification information carried by the data processing request.

In operation S230, the at least one first block-chain data is sent to the first client device in response to determining that the authentication of the first client device is completed, so that the first client device decrypts the at least one first block-chain data to obtain at least one second block-chain data by using at least one block body private key respectively corresponding to the at least one first block-chain data.

According to embodiments of the present disclosure, the client device may be an electronic device installed with various client applications. Client applications may be divided into different types according to different perspectives. For example, according to service functions provided by client applications, client applications may be divided into personal client applications and service client applications. A personal client application may refer to a client application that allows a user to perform a service operation using a function provided by the client application. A service client application may refer to a client application that supports a business service for a user. According to development frameworks of client applications, client applications may be divided into program client applications and webpage client applications. A program client application may refer to a client application that loads an application (APP). A webpage client application may refer to a web client application, and the web client application may include a web browser. According to whether a registration operation is performed by the user, client applications may be divided into registered client applications and non-registered client applications. A registered client application may refer to a client application in which a registration operation is performed by the user in a process of using at least one of a function provided by the client application or a function provided by an application loaded on the client application. A non-registered client application may refer to a client application in which a registration operation is not performed by the user in a process of using a function provided by the client application or a function provided by an application loaded on the client application. The program client application may be a personal client application, a service client application, a registered client application, or a non-registered client application. The webpage client application may be a personal client application, a service client application, a registered client application, or a non-registered client application.

According to embodiments of the present disclosure, the data processing request may be a request initiated by the first client device, or initiated by other client devices and forwarded by the first client device, which is used to acquire block-chain data from various block-chain networks. The data processing request may be generated by a client device according to an input operation, a selection operation, and other operations of the user. The input operation may be, for example, an information input operation performed by the user through an input device such as a keyboard and a microphone in an input control of an interface of a client application on the client device. The selection operation may be, for example, an information selection operation performed by the user using a mouse selection, a touch selection, etc. in a selection control of an interface of a client application in the client device. The first client device may send the data processing request to a platform of processing block-chain data.

According to embodiments of the present disclosure, the object identification information may refer to an information used to uniquely represent an identity of a requester of the data processing request. The requester of the data processing request may refer to a user who controls the client device to initiate the data processing request. Accordingly, the object identification information may refer to a user name, a user ID, a user ID number and other information of the user.

According to embodiments of the present disclosure, the first block-chain network may be a block-chain network created by a system of processing block-chain data, and a server device of the platform of processing the block-chain data may serve as at least a committer node of the first block-chain network. A type of the first block-chain network may include but not be limited to a public block-chain, a consortium block-chain, a private block-chain, a side block-chain, a branch block-chain, etc. The public block-chain network has a TPS (transaction per second) significantly lower than that of the consortium block-chain network or the private block-chain network. For example, the TPS of Ethereum block-chain is generally 20, while the TPS of private block-chain may be close to 100000. In order to improve a read and write efficiency of block-chain data, the type of the first block-chain network may be preferably the consortium block-chain network or the private block-chain network. Accordingly, the server device of the platform of processing the block-chain data may serve as an authorized node in the consortium block-chain network or the private block-chain network.

According to embodiments of the present disclosure, the block-chain data recorded in the first block-chain network may be user data from different data sources. After obtaining a user authorization, it is possible to package the user data into a block and add the block to the first block-chain network.

According to embodiments of the present disclosure, acquiring the first block-chain data based on the object identification information may include determining a relevant target block by matching the object identification information with a relevant identification of the block header of each block in the first block-chain network. The block body data of the relevant target block is the first block-chain data that needs to be acquired.

According to embodiments of the present disclosure, the first block-chain data may include block body data of one or more blocks of the first block-chain network.

According to embodiments of the present disclosure, the encrypted verification information may include an information used for identity authentication and permission authentication of the first client device. For example, the encrypted verification information may include a user name and a password, a biometric information, a predetermined answer to a specific question, a password lock combination, etc. As an optional implementation, the encrypted verification information may be obtained by encrypting the aforementioned types of information. For example, it is possible to perform a hash computation on the aforementioned types of information, and an obtained hash value is the encrypted verification information. Furthermore, in order to ensure a security of the encrypted verification information during an information transmission, it is possible to encrypt the obtained hash value by a digital signature method, an encryption method, etc. to obtain the encrypted verification information. After determining that the first client device has passed the identity authentication based on the encrypted verification information, it is possible to determine a permission of the first client terminal by using a permission management method, such as DAC (Discretionary Access Control), MAC (Mandatory Access Control), RBAC (Role-based Access Control), etc., where the permission may include a data access authority, a data ownership, etc. For example, in a case of a block in which it is determined that the first client device has a data access authority, it is possible to acquire the first block-chain data from the first block-chain network, or acquire the second block-chain data that is obtained by decrypting the first block-chain data. In a case of a block in which it is determined that the first client device has a data ownership, it is possible to share or modify the first block-chain data contained in the first block-chain network upon receiving a request for sharing or modification from the first client device.

According to embodiments of the present disclosure, the second block-chain data may be plaintext data corresponding to the first block-chain data.

According to embodiments of the present disclosure, the first client device may be authenticated based on the encrypted verification information. After it is determined that the authentication is completed, it may be determined that the first client device has a permission to acquire the first block-chain data. Then, the first block-chain data may be returned to the first client device. Through the above technical means, the data communication links between devices only transmit encrypted data, and the block-chain private key used for decrypting the first block-chain data may not be exposed in plaintext or ciphertext, so that the security of block-chain network data may be effectively ensured, which helps to further ensure fidelity and tamper resistance of data.

According to embodiments of the present disclosure, a distributed private key network may be a distributed network including a plurality of nodes. A block body private key generated when the user registering in the block-chain network may be stored in a distributed manner at a specific node of the distributed private key network. A storage form of the block body private key in the distributed private key network is not limited. For example, the block body private key may be divided into a plurality of sub-keys, and each sub-key may be stored at a node. Alternatively, the block body private key may be re-encrypted, the re-encrypted block body private key may be stored at a node, and a key used for re-encryption may be stored at other nodes.

According to embodiments of the present disclosure, authenticating the first client device based on the encrypted verification information may include authenticating the first client device sequentially by the platform of processing the block-chain data and the distributed private key network. Specifically, the encrypted verification information may be obtained by the first client device digitally signing the private key digest information using an object private key, and the private key digest information may be obtained by the first client device concatenating and hashing at least one block body private key respectively corresponding to the at least one first block-chain data. Authenticating the first client device based on the encrypted verification information carried by the data processing request may include the following operations.

An object public key is obtained based on the object identification information, where the object public key corresponds to the object private key. The encrypted verification information is verified using the object public key to obtain a first digest information. In a case that the encrypted verification information is verified successfully, the first digest information is the private key digest information. The object identification information and the first digest information are sent to the distributed private key network, so that the distributed private key network may determine at least one block body private key according to the object identification information, concatenate and hash the at least one block body private key to obtain a second digest information, and determine an authentication result of the first client device based on a matching result of the first digest information and the second digest information.

According to embodiments of the present disclosure, the object identification information may include an information that represents the first client device and/or the requester of the data processing request. With such information, the platform of processing the block-chain data may acquire the object public key corresponding to the first client device and/or the requester of the data processing request from a storage unit.

According to embodiments of the present disclosure, verifying the encrypted verification information using the object public key may include decrypting the encrypted verification information using the object public key.

According to embodiments of the present disclosure, the first digest information may be the same as or different from the private key digest information. Specifically, when either the object identification information or the encrypted verification information is tampered with or disturbed during the data transmission from the first client device to the platform of processing the block-chain data, the obtained first digest information may be distinguished from the private key digest information. When the object identification information and the encrypted verification information are both correct, the obtained first digest information may be the private key digest information. Furthermore, when the first digest information is different from the private key digest information, the first digest information is necessarily not matched with the second digest information.

According to embodiments of the present disclosure, the private key digest information, the first digest information, and the second digest information may all be represented as a hash value, which may be calculated using the same hash algorithm. The hash algorithm may be selected according to specific application scenarios and is not limited here.

According to embodiments of the present disclosure, it is possible to obtain an authentication result indicating that the authentication of the first client device has completed when it is determined that the first digest information is matched with the second digest information, and to obtain an authentication result indicating that the authentication of the first client device has not completed when it is determined that the first digest information is not matched with the second digest information.

According to embodiments of the present disclosure, by sequentially authenticating the first client device by the platform of processing the block-chain data and the distributed private key network, it is possible to avoid a data centralization and ensure a data security.

According to embodiments of the present disclosure, when the requester initiates a data processing request for the first time, that is, when the at least one first block-chain data does not exist in the first block-chain network, it is possible to acquire the at least one first block-chain data from at least one second block-chain network by means of cross-chain data acquisition.

According to embodiments of the present disclosure, the second block-chain network may be a storage unit of a service information system. The user may register and authorize in the second block-chain network. In a process of using the service information system to conduct service, generated service data may be collected by the system, and after the service data is encrypted, the encrypted data may be added to the second block-chain network. The service data may be encrypted using a block body public key. The block body public key may be generated in a process of the user registering on the second block-chain network. For example, the block body public key and the block body private key may be generated based on a character string input by the user using an encryption client application provided in the client device, and the block body public key may be sent to the service information system during the registration process. When adding data, it is possible to package the service data generated during each fixed time period into a block and add the block to the second block-chain network. The block header of that block may include an information that may be viewed in plaintext, such as an add time, a stakeholder identification, a parent block hash value, etc.

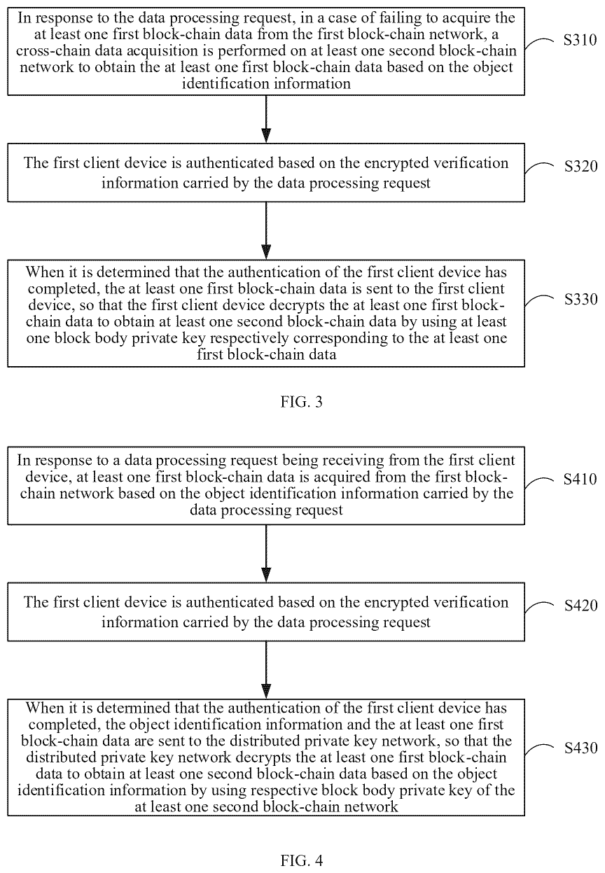

FIG. 3 schematically shows a flowchart of a method of processing block-chain data according to other embodiments of the present disclosure.

As shown in FIG. 3, the method includes operations S310 to S330.

In operation S310, in response to the data processing request, in a case of failing to acquire the at least one first block-chain data from the first block-chain network, a cross-chain data acquisition is performed on at least one second block-chain network to obtain the at least one first block-chain data based on the object identification information.

In operation S320, the first client device is authenticated based on the encrypted verification information carried by the data processing request.

In operation S330, when it is determined that the authentication of the first client device has completed, the at least one first block-chain data is sent to the first client device, so that the first client device decrypts the at least one first block-chain data to obtain at least one second block-chain data by using at least one block body private key respectively corresponding to the at least one first block-chain data.

According to embodiments of the present disclosure, failing to acquire the at least one first block-chain data from the first block-chain network means that the object identification information is not matched with any of the block headers of a plurality of blocks included in the first block-chain network.

According to embodiments of the present disclosure, operations S320 to S330 may be implemented using the same or similar methods provided in the aforementioned embodiments, which will not be repeated here.

According to embodiments of the present disclosure, a cross-chain acquisition of the first block-chain data from each of at least one block-chain network based on the object identification information carried by the data processing request may be achieved using a cross-chain method, which may be, for example, a cross-chain method based on a cross-chain node. Specifically, the cross-chain method may include the following operations.

For each second block-chain network, a cross-chain node of the second block-chain network is determined. The first block-chain data is acquired through the cross-chain node based on a node type of the cross-chain node.

According to embodiments of the present disclosure, the cross-chain node may be a block-chain node that may provide a communication interface to the outside, and an external device may establish a communication link with the cross-chain node through the communication interface by using an agreed communication protocol.

According to embodiments of the present disclosure, the type of the cross-chain node may be related to a type of the second block-chain network, and specifically to a node permission allocation of different types of second block-chain networks. For example, when the second block-chain network is a consortium block-chain network, the cross-chain node may be an authorized node in the consortium block-chain network because a read permission, a transaction permission and a committer permission of the consortium block-chain network are all allocated to the authorized node, and an unauthorized external node is not allowed for access. For another example, when the second block-chain network is a private block-chain network, the cross-chain node may be authorized or unauthorized nodes in the private block-chain network when performing a data read operation, while the cross-chain node may only be limited authorized nodes in the private block-chain network when performing a data update operation because in the private block-chain network, a read permission is completely private, while a transaction permission and a committer permission are allocated to limited authorized nodes.

According to embodiments of the present disclosure, for another example, when the second block-chain network is a public block-chain network, the cross-chain node may be any node in the public block-chain network, such as a light node, a full node, etc., or any node outside the public block-chain network, because any person may have read, transaction, and committer permissions for the public block-chain network. The light node in the second block-chain network may be a node that does not store or maintain a complete block-chain ledger but only stores a minimum amount of state to send or transmit transaction information. The light node may hold only the block headers of all blocks in the block-chain ledger, and may verify an existence of a payment transaction with the help of Merkel roots in the block headers. The full node may be a node holding a complete block-chain ledger, which needs to occupy memory to synchronize all block-chain data. The full node may independently verify all transactions on the block-chain and update data in real-time, and is mainly responsible for broadcasting and verifying block-chain transactions. The data recorded on different nodes may be synchronized through consensus mechanism.

According to embodiments of the present disclosure, the cross-chain acquisition of the first block-chain data may be different according to different types of the cross-chain nodes of different second block-chain networks in the at least one second block-chain network.

For example, when it is determined that the cross-chain node is a full node, a data acquisition request containing the object identification information may be sent to the cross-chain node to obtain the first block-chain data based on first feedback data returned by the cross-chain node. In this case, the first block-chain data may be acquired efficiently.

According to embodiments of the present disclosure, the first feedback data may be obtained from a ledger of the cross-chain node based on the object identification information, and a specific method of obtaining the first feedback data is not limited here. The ledger of the cross-chain node may refer to a complete block-chain ledger maintained in the storage unit of that cross-chain node.

According to embodiments of the present disclosure, the first feedback data returned by the cross-chain node may be a data packet including one or more blocks. Obtaining the first block-chain data based on the first feedback data may include removing the block headers of one or more blocks included in the data packet, and obtaining the first block-chain data by combination or concatenation.

According to embodiments of the present disclosure, by directly setting the cross-chain node as a full node of the public block-chain network, it is possible to reduce a time consumption of data acquisition and save a bandwidth.

For another example, when it is determined that the cross-chain node is a light node, a data acquisition request containing the object identification information may be sent to a full node of the second block-chain network through the cross-chain node, so as to obtain the first block-chain data based on second feedback data returned by the full node through the cross-chain node.

According to embodiments of the present disclosure, the second feedback data is obtained from a ledger of the full node based on the object identification information forwarded by the cross-chain node, and a specific method of obtaining the second feedback data is not limited here. The ledger of the full node may refer to a complete block-chain ledger maintained in the storage unit of that full node.

According to embodiments of the present disclosure, the light node may act as a proxy node to forward instructions received through an interface, to the full node. As an optional implementation, the light node may pre-verify the instructions by using the block headers of the blocks in the ledger of the light node before forwarding the instructions, and the instructions that fail to pass the pre-verification may not be forwarded. For example, when querying a payment transaction, it is possible to use the Merkle root contained in the block header for pre-verification, that is, to determine whether the payment transaction has been verified. When it is determined that the payment transaction has been verified, it may be determined that the payment transaction has been recorded in the second block-chain network.

According to the embodiment of the present disclosure, each full node in the second block-chain network may be represented as a distributed network. That is, the full node may logically be represented as a single node in the second block-chain network, and physically, the full node may be composed of a plurality of distributed nodes. Accordingly, the block-chain ledger of the full node may be divided into a plurality of sub-ledgers, which may be stored in a plurality of distributed nodes in a distributed manner, so as to achieve a performance expansion of the full node and avoid a problem of data hijacking. The light node may broadcast the data acquisition request to each distributed node of the full nodes, and the plurality of distributed nodes may extract sub-data from respective sub-ledgers and send the sub-data to the light node. The light node may combine and concatenate the sub-data to obtain the second feedback data.

According to embodiments of the present disclosure, when the cross-chain node is any node outside the public block-chain network, the cross-chain node may access the public block-chain network through a URL (Universal Resource Locator) address, a specific interface, etc., and acquire the first block-chain data from various nodes of the public block-chain network. Specifically, for each second block-chain network, if the second block-chain network is a public block-chain network, it is possible to broadcast the data acquisition request containing the object identification information to a plurality of block-chain nodes included in the second block-chain network, and obtain the first block-chain data based on respective third feedback data of the plurality of block-chain nodes.

According to embodiments of the present disclosure, the third feedback data may be obtained by the block-chain node from the ledger of the block-chain node based on the object identification information.

According to embodiments of the present disclosure, obtaining the first block-chain data based on the third feedback data returned by the plurality of block-chain nodes may include comparing a plurality of third feedback data and using the third feedback data with the highest occurrence as the first block-chain data.

According to embodiments of the present disclosure, with the help of the broadcasting mechanism of the public block-chain network, a range of data source nodes may be further expanded, and a reliability of the obtained data may be improved.

According to embodiments of the present disclosure, as an optional implementation, the first client device may also be authenticated by the platform of processing the block-chain data alone. Specifically, before processing the first block-chain data, the first client device may be authenticated to determine whether the requester has a corresponding permission. If the authentication is completed, it may be determined that the requester has the corresponding permission and it may be considered to have obtained the user authorization to proceed with the decryption of the first block-chain data. If the authentication is not completed, it may be considered that the user may be an illegal user and has not obtained authorization from a legitimate user. Since the first block-chain data is ciphertext data, the first block-chain data obtained at this time may be garbled data, which does not affect the privacy and security of the block-chain data. As an optional implementation, it is also possible to firstly authenticate the first client device, and then acquire the first block-chain data across chains from the at least one second block-chain network based on the object identification information after determining that the authentication of the first client device is completed, which is not limited here.

According to embodiments of the present disclosure, the information on which the authentication is based may be an encrypted verification information. In order to ensure that the encrypted verification information is credible, that is, the encrypted verification information is not tampered with in the process of information transmission, it is possible to encrypt an original authentication information. The encryption may include a symmetric encryption, an asymmetric encryption, a digital signature, and so on. Taking a digital signature as an example, the first client device may encrypt a verification information plaintext to obtain an encrypted verification information by using an object private key held by the first client device. That is, the encrypted verification information may be obtained by the first client device digitally signing the verification information plaintext using the object private key.

According to embodiments of the present disclosure, the verification information plaintext may be obtained by the first client device hashing an encrypted combination information.

According to embodiments of the present disclosure, an object key pair may be generated by the first client device based on data such as random numbers, device numbers, and device generation dates. The object key pair may include an object private key and an object public key. The object private key may be burned in hardware facilities of the device, so that the object private key is only held by the first client device and may not be obtained by external devices. The object public key may be publicly disclosed in advance, so that other devices may use the object public key for verification.

According to embodiments of the present disclosure, authenticating the first client device based on the encrypted verification information carried by the data processing request may include the following operations.

A reserved encrypted combination information and an object public key are obtained based on the object identification information, where the object public key corresponds to the object private key. The encrypted verification information is verified using the object public key, so as to obtain a first verification information. A hash computation is performed on the reserved encrypted combination information to obtain a second verification information. An authentication result of the first client device is determined based on a matching result of the first verification information and the second verification information.

According to embodiments of the present disclosure, the object identification information may include an information that may represent the first client device, through which information the reserved encrypted combination information and the object public key corresponding to the first client device may be obtained from the storage unit.

According to embodiments of the present disclosure, the encrypted combination information may be an information filled in by the requester of the data processing request during registration. For example, the encrypted combination information may include at least one selected from: an answer text for a predetermined question, a password string, or a biometric information. When the requester registers, the requester may be required to set answers to one or more predetermined questions by setting a password or setting a password retrieval security question, and the answer text for the predetermined question includes a question number selected by the requester and the answer filled in at the time of registration. The password string may be a secondary password, a security password, etc., set by the requester at the time of registration, or a random number or random string entered by the requester at the time of registration. The biometric information may include information such as portrait characteristics, iris, fingerprints, voiceprints, etc. of the requester. The biometric information may be collected by the first client device. Accordingly, the reserved encrypted combination information may be an information stored by the platform of processing the block-chain data when the requester of the data processing request registers and fills in the information. The reserved encrypted combination information may also include at least one selected from: an answer text for a predetermined question, a password string, or a biometric information.

According to embodiments of the present disclosure, the verification information plaintext may be a hash value. The hash value may be directly input by the requester to the first client device when the requester initiates the data processing request. Alternatively, the first client device may maintain a mapping table, each item of which includes a mapping from a simple information to a hash value. When initiating the data processing request, the requester may input the simple information, and the first client device may acquire the corresponding verification information plaintext from the mapping table by using the simple information. The simple information may include a string, a combination of numbers, and so on.

According to embodiments of the present disclosure, verifying the encrypted verification information using the object public key may include decrypting the encrypted verification information using the object public key.

According to embodiments of the present disclosure, the first verification information may be the same as or different from the verification information plaintext. Specifically, when either the object identification information or the encrypted verification information is tampered with or disturbed in a process of data transmission from the first client device to the platform of processing the block-chain data, the obtained first verification information may be distinguished from the verification information plaintext. When both the object identification information and the encrypted verification information are correct, the obtained first verification information may be the verification information plaintext. Furthermore, when the first verification information is different from the verification information plaintext, the first verification information is necessarily not matched with the second verification information.

According to embodiments of the present disclosure, it is possible to obtain an authentication result indicating that the authentication of the first client device has completed when it is determined that the verification information plaintext is matched with the reserved verification information, and to obtain an authentication result indicating that the authentication of the first client device has not completed when it is determined that the verification information plaintext is not matched with the reserved verification information.

According to embodiments of the present disclosure, by authenticating the first client device using the reserved verification information, it is possible to help user memory, avoid data centralization, and ensure data security.

According to embodiments of the present disclosure, the first block-chain data may be decrypted in a distributed private key network.

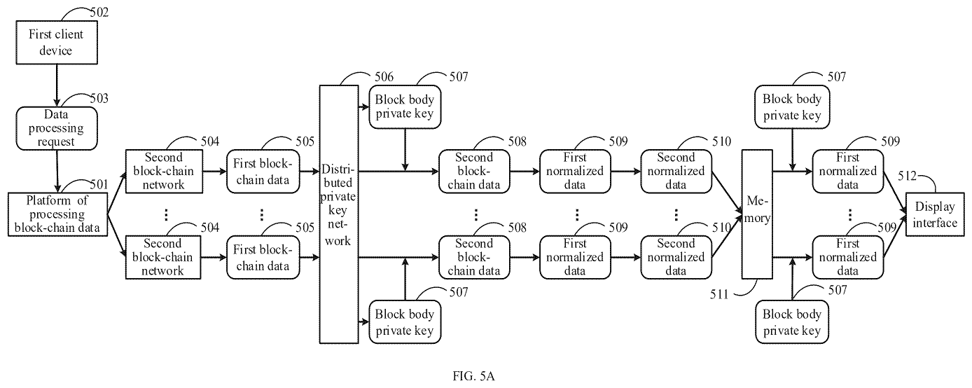

FIG. 4 schematically shows a flowchart of a method of processing block-chain data according to still other embodiments of the present disclosure.

As shown in FIG. 4, the method includes operations S410 to S430.

In operation S410, in response to a data processing request being receiving from the first client device, at least one first block-chain data is acquired from the first block-chain network based on the object identification information carried by the data processing request.

In operation S420, the first client device is authenticated based on the encrypted verification information carried by the data processing request.

In operation S430, when it is determined that the authentication of the first client device has completed, the object identification information and the at least one first block-chain data are sent to the distributed private key network, so that the distributed private key network decrypts the at least one first block-chain data to obtain at least one second block-chain data based on the object identification information by using respective block body private key of the at least one second block-chain network.

According to embodiments of the present disclosure, the block body private key may be stored in a plurality of distributed nodes of a distributed private key network in a distributed manner, or stored in at least part of a plurality of distributed nodes. The private key data stored by each distributed node may be partial plaintext data of the block body private key, or partial ciphertext data of the block body private key obtained using various encryption methods, which is not limited here. The private key data stored by each distributed node may be partial data of a block body private key, or may include respective partial data of a plurality of block body private keys, which is not limited here.

According to embodiments of the present disclosure, by maintaining the block body private key in a distributed private key network, the block body private key may not be separately exposed to the outside in a form of plaintext or ciphertext, that is, the block body private key may not be accessed and obtained by external devices, so that the security of data in the block-chain network may be ensured.

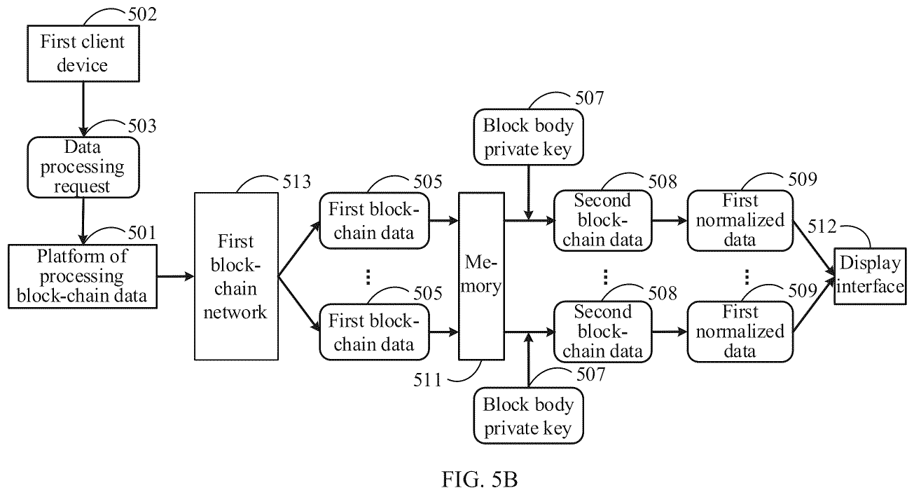

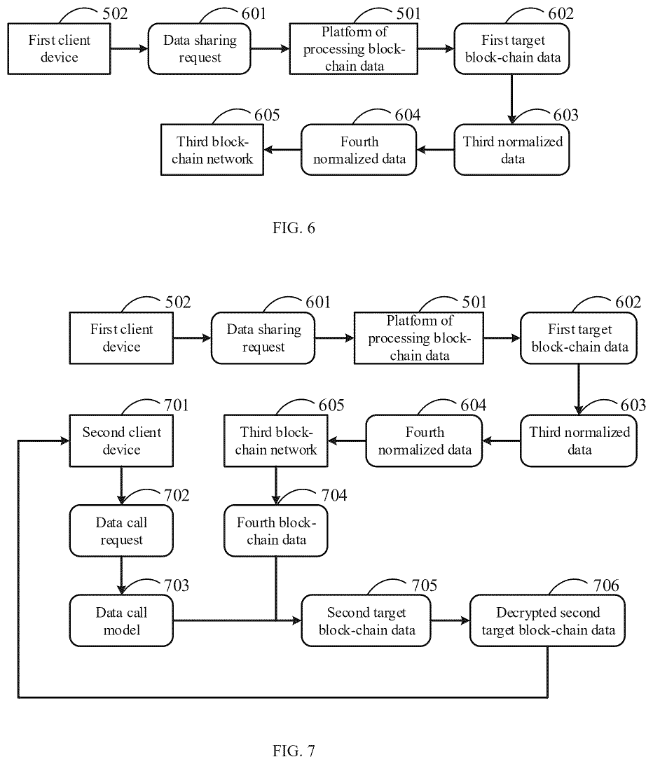

The method of processing the block-chain data shown in FIG. 2 will be further described below in conjunction with specific embodiments with reference to FIG. 5A to FIG. 5B, FIG. 6 and FIG. 7.

According to embodiments of the present disclosure, after obtaining the first block-chain data or the second block-chain data, the platform of processing the block-chain data may display the first block-chain data or the second block-chain data on the first client device by viewing in place. Viewing block-chain data in place may include asynchronous viewing of data, synchronous viewing of data, and other methods.

FIG. 5A schematically shows a schematic diagram of a method of asynchronously viewing block-chain data according to embodiments of the present disclosure.

As shown in FIG. 5A, the method of asynchronously viewing block-chain data may be used when the requester initiates a data processing request for the first time. Alternatively, the method of asynchronously viewing block-chain data may be used when the requester determines that new data exists in the at least one second block-chain network.

According to embodiments of the present disclosure, in response to receiving a data processing request 503 from a first client device 502, a platform 501 of processing block-chain data may acquire first block-chain data 505 across chains from each second block-chain network 504 based on an object identification information carried by the data processing request 503. After determining that an authentication of the first client device 502 has completed, the platform 501 of processing the block-chain data may send the first block-chain data 505 and the object identification information contained in the data processing request 503 to a distributed private key network 506. The distributed private key network 506 may decrypt the first block-chain data 505 to obtain second block-chain data 508 according to the object identification information by using a block body private key 507. The distributed private key network 506 may return the second block-chain data 508 to the platform 501 of processing the block-chain data.

According to embodiments of the present disclosure, for each second block-chain network 504, the platform 501 of processing the block-chain data may perform a text normalization on the received second block-chain data 508 to obtain first normalized data 509, then encrypt the first normalized data 509 to obtain second normalized data 510. The platform 501 of processing the block-chain data may write the second normalized data 510 into a memory 511.

According to embodiments of the present disclosure, the first client device 502 may initiate an asynchronous data viewing request by accessing the memory 511 using a predetermined interface. In response to detecting that the first client device 502 accesses the memory 511 through the predetermined interface, the platform 501 of processing the block-chain data may send respective second normalized data 510 of the at least one second block-chain network 504 to the first client device 502. For second block-chain network 504, the first client device 502 may decrypt the second normalized data 510 of the second block-chain network 504 to obtain the first normalized data 509 by using the block body private key 507 corresponding to the second block-chain network 504, and render and display the first normalized data 509 on a display interface 512 of the first client device 502.

According to embodiments of the present disclosure, the text normalization may be achieved, for example, using a text classification service. Through normalization, various words and phrases used in the second block-chain data 508 may be unified. For example, for an item of spoon, the second block-chain data 508 may use a variety of aliases such as scoop, porcelain spoon, soup ladle, rice ladle, water ladle, etc. After normalization, the above-mentioned aliases may be unified as spoon. In addition, through normalization, various types of data designed in the second block-chain data 508 may be classified according to predetermined types. Taking data in medical block-chain as an example, the second block-chain data 508 may be classified into categories such as user name, user gender, consultation time, disease type, drug type, etc.

According to embodiments of the present disclosure, the data stored in the memory 511 may be periodically cleaned according to cleaning rules. The cleaning rules may include cleaning by user viewing time, cleaning by data storage time, and so on.

According to embodiments of the present disclosure, after the response to the data processing request of the requester is completed, that is, when at least one first block-chain data is obtained across chains from at least one second block-chain network, the at least one first block-chain data may be added to the first block-chain network.

FIG. 5B schematically shows a schematic diagram of a method of synchronously viewing block-chain data according to embodiments of the present disclosure.

As shown in FIG. 5B, the method of synchronously viewing the block-chain data may be used when the requester initiates a data processing request for the second time or later, that is, when the method of synchronously viewing the block-chain data is used, the at least one first block-chain data may have already been recorded in the first block-chain network. Alternatively, the method of synchronously viewing the block-chain data may also be used at the same time as the requester initiates a first data processing request for the first time, which is not limited here.

According to embodiments of the present disclosure, in response to receiving the data processing request 503 from the first client device 502, the platform 501 of processing the block-chain data may acquire the at least one first block-chain data 505 from the first block-chain network 513 based on the object identification information carried by the data processing request 503.

According to embodiments of the present disclosure, the platform 501 of processing the block-chain data may write the at least one first block-chain data 505 into the memory 511.

According to embodiments of the present disclosure, the first client device 502 may access the memory 511 through a predetermined interface while initiating the data processing request 503. In response to detecting that the first client device 502 accesses the memory 511 through the predetermined interface, the platform 501 of processing the block-chain data may send respective first block-chain data 505 of the at least one second block-chain network 504 to the first client device 502.

According to embodiments of the present disclosure, the first client device 502 may decrypt respective first block-chain data 505 of the at least one second block-chain network 504 to obtain at least one second block-chain data 508 by using at least one block body private key 507 respectively corresponding to the at least one second block-chain network 504, call a text classification service to normalize the at least one second block-chain data 508 to obtain at least one first normalized data 509, and render and display the at least one first normalized data 509 on the display interface 512 of the first client device.

According to embodiments of the present disclosure, by viewing data in place as described above, the second normalized data or the first block-chain data may not be written to a disk associated with the platform of processing the block-chain data, so that a possibility of data leakage may be reduced.

According to embodiments of the present disclosure, the requester of the data processing request may be an owner of the second block-chain data. The second block-chain data may be generated by the requester in the network and collected by the at least one second block-chain network. The requester may differentially define the held second block-chain data to process different data with different strategies. For example, the requester may publicly disclose partial data in the held second block-chain data and share data with other users, so as to obtain other services provided by the platform of processing the block-chain data.

FIG. 6 schematically shows a schematic diagram of a method of sharing block-chain data according to embodiments of the present disclosure.

As shown in FIG. 6, the platform 501 of processing the block-chain data may provide a data sharing option for each second block-chain data 508 when displaying the second block-chain data 508. The requester may determine the second block-chain data that needs to be shared by selecting the option for each second block-chain data 508. The first client device 502 may generate a data sharing request 601 based on the second block-chain data that needs to be shared.

According to embodiments of the present disclosure, in response to receiving a data sharing request 601 from the first client device 502, the platform 501 of processing the block-chain data may acquire first target block-chain data 602 carried by the data sharing request 601. The platform 501 of processing the block-chain data may perform a text normalization on the first target block-chain data 602 to obtain third normalized data 603. The platform 501 of processing the block-chain data may encrypt the third normalized data 603 to obtain fourth normalized data 604. The platform 501 of processing the block-chain data may add the fourth normalized data 604 to a third block-chain network 605.

According to embodiments of the present disclosure, the third normalized data 603 may be encrypted using various encryption methods. Various encryption methods may include any symmetric encryption method, such as DES (Data Encryption Standard), AES (Advanced Encryption Standard), etc., and may also include any asymmetric encryption method, such as RSA, ECC (Elliptic Curve Cryptography), etc., which is not limited here.

According to embodiments of the present disclosure, taking medical block-chain as an example, for example, the requester may be a patient user who urgently needs bone marrow matching, and the first target block-chain data of the requester may be matching data of the requester. By sharing the first target block-chain data to the outside, it is possible to achieve a mutual assistance in bone marrow matching more conveniently. For another example, the first target block-chain data of the requester may be about a diagnosis and treatment process of a particular disease, and the diagnosis and treatment process may include medication data. By sharing the first target block-chain data to the outside, it may be used as one of basic contents of big data to guide medication recommendations for more uncured patients.

According to embodiments of the present disclosure, after the fourth normalized data is added to the third block-chain network, the fourth normalized data may be called by any user.

FIG. 7 schematically shows a schematic diagram of a method of calling block-chain data according to embodiments of the present disclosure.

As shown in FIG. 7, after the fourth normalized data 604 is added to the third block-chain network 605, in response to a data call request 702 from a second client device 701, the platform 501 of processing the block-chain data may determine a data call model 703 based on a call type information carried by the data call request 702.

According to embodiments of the present disclosure, the platform 501 of processing the block-chain data may process fourth block-chain data 704 included in the third block-chain network 605 by using the data call model 703, so as to obtain second target block-chain data 705.

According to embodiments of the present disclosure, the platform 501 of processing the block-chain data may decrypt the second target block-chain data 705 and send decrypted second target block-chain data 706 to the second client device 701.

According to embodiments of the present disclosure, the data call model 703 may be a data model in a preset algorithm library. The data models in the preset algorithm library may include recommendation models, matching models, prediction models, etc., which may be set according to specific application scenarios and not limited here. An input port and an output port of each data model may be provided to a corresponding interface of the platform 501 of processing the block-chain data. Through the interface, the platform 501 of processing the block-chain data may input data to the data model and extract data that has been processed by the data model from the data model.

According to embodiments of the present disclosure, the fourth block-chain data 704 may include not only the fourth normalized data 604 provided by the requester of the data processing request 503, but also the block-chain data shared by other users to the third block-chain network 605, which is not limited here.

According to embodiments of the present disclosure, taking the data call model 703 being a user recommendation model in the medical block-chain as an example, a user A may input a user own information, such as specific attribute values of “user name”, “user gender”, “consultation time”, “disease type”, “drug type” and other attributes, through an input interface of the user recommendation model. These specific attribute values may form a user vector A. By using the user recommendation model, a similarity matching with respect to the user vector A may be calculated through a data matrix composed of basic contents of big data, so that another set of user vector B composed of specific attribute values of “user name”, “user gender”, “consultation time”, “disease type”, “drug type” and other attributes may be feedback to the user A through the output interface. The user A may retrieve detailed information about the diagnosis and treatment process provided by the user B from the third block-chain network based on identity information such as “user gender” in the user vector B. Alternatively, the platform may feedback a plurality of sets of user vectors, such as user vector B, user vector C, user vector D, etc., to the user A for selection.

As an optional implementation, the second target block-chain data 705 may be decrypted using a decryption method corresponding to the encryption method used for encrypting the third normalized data 603. Taking asymmetric encryption as an example, the platform 501 of processing the block-chain data may generate a platform private key and a platform public key. When the user shares data, the platform 501 of processing the block-chain data may encrypt the shared data using the platform private key and add the encrypted shared data to a third block-chain network. When other users make data calls, the platform 501 of processing the block-chain data may decrypt the data that needs to be called by using the platform public key, and then send the decrypted data to other users. Alternatively, the platform 501 of processing the block-chain data may also provide the platform public key to a user who has an authority to call data. When the user makes a data call, the platform 501 of processing the block-chain data may directly send the data to be called from the third block-chain network to the user, and the data to be called may be decrypted by the user using the platform public key.

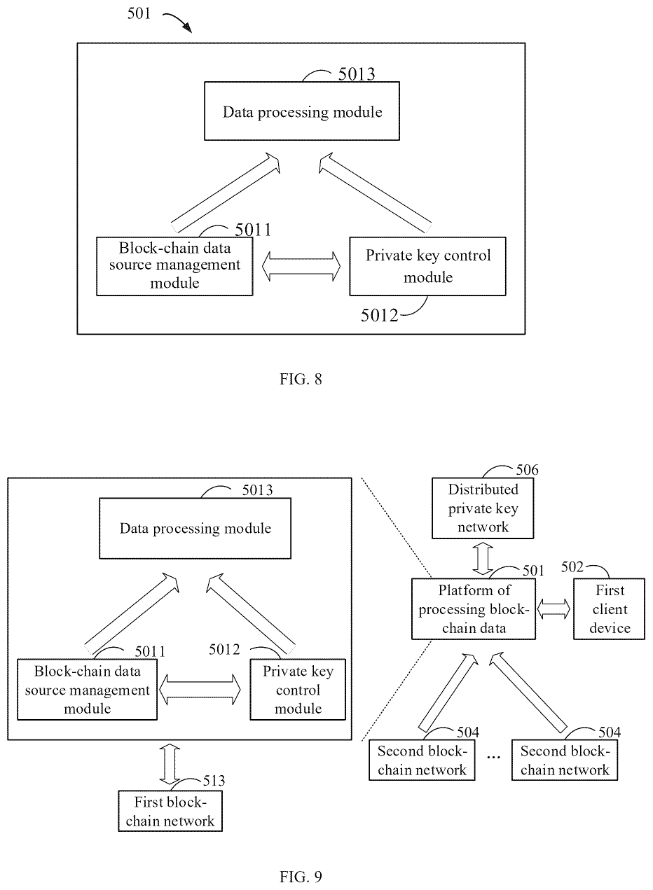

FIG. 8 schematically shows a schematic diagram of a platform of processing block-chain data according to embodiments of the present disclosure.

As shown in FIG. 8, the platform 501 of processing the block-chain data may include a block-chain data source management module 5011, a private key control module 5012, and a data processing module 5013.

The block-chain data source management module 5011 is used to acquire, in response to receiving a data processing request from a first client device, at least one first block-chain data from a first block-chain network based on an object identification information carried by the data processing request.

The private key control module 5012 is used to authenticate the first client device based on an encrypted verification information carried by the data processing request.

The data processing module 5013 is used to send the at least one first block-chain data to the first client device in response to determining that the authentication of the first client device is completed, so that the first client device decrypts the at least one first block-chain data to obtain at least one second block-chain data by using at least one block private key respectively corresponding to the at least one first block-chain data.

According to embodiments of the present disclosure, the encrypted verification information is obtained by the first client device digitally signing a private key digest information using an object private key, and the private key digest information is obtained by the first client device concatenating and hashing the at least one block body private key respectively corresponding to the at least one first block-chain data.

According to embodiments of the present disclosure, the private key control module 5012 is used to: obtain an object public key based on the object identification information, where the object public key corresponds to the object private key; verify the encrypted verification information using the object public key to obtain a first digest information, where the first digest information is the private key digest information if the encrypted verification information is verified successfully; and sending the object identification information and the first digest information to a distributed private key network, so that the distributed private key network determines at least one block body private key according to the object identification information, concatenate and hash the at least one block body private key to obtain a second digest information, and determine an authentication result of the first client device based on a matching result of the first digest information and the second digest information.

According to embodiments of the present disclosure, the block-chain data source management module 5011 is used to: perform, in response to the data processing request, a cross-chain data acquisition on at least one second block-chain network to obtain the at least one first block-chain data based on the object identification information, in a case of failing to acquire the at least one first block-chain data from the first block-chain network.

According to embodiments of the present disclosure, the block-chain data source management module 5011 is used to: for each of the at least one second block-chain network, determine a cross-chain node of the second block-chain network; and acquire the first block-chain data through the cross-chain node based on a node type of the cross-chain node.

According to embodiments of the present disclosure, the block-chain data source management module 5011 is used to: send, in response to determining that the cross-chain node is a full node, a data acquisition request containing the object identification information to the cross-chain node, so as to obtain the first block-chain data based on first feedback data returned by the cross-chain node. The first feedback data is obtained by the cross-chain node from a ledger of the cross-chain node based on the object identification information.

According to embodiments of the present disclosure, the block-chain data source management module 5011 is used to: send, in response to determining that the cross-chain node is a light node, a data acquisition request containing the object identification information to a full node of the second block-chain network through the cross-chain node, so as to obtain the first block-chain data based on second feedback data returned by the full node through the cross-chain node. The second feedback data is obtained by the full node from a ledger of the full node based on the object identification information forwarded by the cross-chain node.

According to embodiments of the present disclosure, the block-chain data source management module 5011 is used to: for each of the at least one second block-chain network, broadcast a data acquisition request containing the object identification information to a plurality of block-chain nodes contained in the second block-chain network, in response to the second block-chain network being a public block-chain network; and obtain the first block-chain data based on third feedback data respectively returned by the plurality of block-chain nodes. The third feedback data is obtained by the block-chain node from a ledger of the block-chain node based on the object identification information.

According to embodiments of the present disclosure, the encrypted verification information is obtained by the first client device digitally signing a verification information plaintext using an object private key, and the verification information plaintext is obtained by the first client device hashing an encrypted combination information.

According to embodiments of the present disclosure, the private key control module 5012 is used to: obtain a reserved encrypted combination information and an object public key based on the object identification information, where the object public key corresponds to the object private key; verify the encrypted verification information using the object public key to obtain a first verification information, where the first verification information is the verification information plaintext in response to determining that the encrypted verification information being verified successfully; hash the reserved encrypted combination information to obtain a second verification information; and determine an authentication result of the first client device based on a matching result of the first verification information and the second verification information.

According to embodiments of the present disclosure, the encrypted combination information or the reserved encrypted combination information includes at least one selected from: an answer text for a predetermined question, a password string, or a biometric information.

According to embodiments of the present disclosure, the private key control module 5012 is used to: send the object identification information and the at least one first block-chain data to a distributed private key network in response to determining that an authentication of the first client device is completed, so that the distributed private key network decrypts the at least one first block-chain data to obtain at least one second block-chain data based on the object identification information by using respective block body private key of the at least one second block-chain network.

According to embodiments of the present disclosure, the data processing module 5013 is used to: for each of the at least one second block-chain network, perform a text normalization on second block-chain data of the second block-chain network to obtain first normalized data; encrypt the first normalized data to obtain second normalized data by using a block body public key corresponding to the second block-chain network, where the block body public key corresponds to the block body private key; write the second normalized data into a memory; and send respective second normalized data of the at least one second block-chain network to the first client device in response to detecting that the first client device accesses the memory through a predetermined interface, where the first client device is configured to decrypt, for each of the at least one second block-chain network, the second normalized data of the second block-chain network to obtain the first normalized data by using a block body private key corresponding to the second block-chain network, and render and display the first normalized data on a display interface of the first client device.

According to embodiments of the present disclosure, the data processing module 5013 is used to: add the at least one first block-chain data to the first block-chain network in response to the at least one first block-chain data being obtained by performing the cross-chain acquisition on the at least one second block-chain network.

According to embodiments of the present disclosure, the data processing module 5013 is used to: write the at least one first block-chain data into a memory; and send the at least one first block-chain data to the first client device in response to detecting that the first client device accesses the memory through a predetermined interface, where the first client device is configured to decrypt the at least one first block-chain data to obtain at least one second block-chain data by using at least one block body private key respectively corresponding to the at least one first block-chain data, call a text classification service to normalize the at least one second block-chain data to obtain at least one first normalized data, and render and display the at least one first normalized data on a display interface of the first client device.

According to embodiments of the present disclosure, the data processing module 5013 is used to: acquire, in response to a data sharing request from the first client device, first target block-chain data carried by the data sharing request; perform a text normalization on the first target block-chain data to obtain third normalized data; encrypt the third normalized data to obtain fourth normalized data; and add the fourth normalized data to a third block-chain network.

According to embodiments of the present disclosure, the data processing module 5013 is used to: determine, in response to a data call request from a second client device, a data call model based on a call type information carried by the data call request; process fourth block-chain data contained in the third block-chain network to obtain second target block-chain data by using the data call model, where the fourth block-chain data includes the fourth normalized data; and decrypt the second target block-chain data, and send decrypted second target block-chain data to the second client device.

It should be noted that a part for the platform of processing the block-chain data in embodiments of the present disclosure corresponds to a part for the method of processing the block-chain data in embodiments of the present disclosure. For detailed description of the platform of processing the block-chain data, reference may be made to the part for the method of processing the block-chain data, which will not be repeated here.

FIG. 9 schematically shows a schematic diagram of a system of processing block-chain data according to embodiments of the present disclosure.

As shown in FIG. 9, the system of processing the block-chain data may include a first client device 502, a first block-chain network 513, a platform 501 of processing block-chain data, and a distributed private key network 506.

The platform 501 of processing the block-chain data is used to: acquire, in response to receiving a data processing request from a first client device, at least one first block-chain data from a first block-chain network based on an object identification information carried by the data processing request; authenticate the first client device based on an encrypted verification information carried by the data processing request; and send the at least one first block-chain data to the first client device in response to determining that an authentication of the first client device is completed.

The first client device 502 is used to: decrypt the at least one first block-chain data to obtain at least one second block-chain data by using at least one block body private key respectively corresponding to the at least one first block-chain data.

According to embodiments of the present disclosure, the system of processing the block-chain data may further include at least one second block-chain network 504.

According to embodiments of the present disclosure, the platform 501 of processing the block-chain data is used to: perform, in response to the data processing request, a cross-chain data acquisition on at least one second block-chain network to obtain the at least one first block-chain data based on the object identification information, in a case of failing to acquire the at least one first block-chain data from the first block-chain network.

According to embodiments of the present disclosure, the platform 501 of processing the block-chain data is used to: send the object identification information and the at least one first block-chain data to a distributed private key network in response to determining that an authentication of the first client device is completed.

According to embodiments of the present disclosure, the distributed private key network 506 is used to: decrypt the at least one first block-chain data to obtain at least one second block-chain data based on the object identification information by using respective block body private key of the at least one second block-chain network.

According to embodiments of the present disclosure, the distributed private key network 506 is used to: determine, in response to receiving the object identification information and the at least one first block-chain data from the platform of processing the block-chain data, at least one target node from a plurality of distributed nodes based on the object identification information; obtain respective block body private key of the at least one second block-chain network based on private key data respectively stored by the at least one target node; decrypt the at least one first block-chain data to obtain at least one second block-chain data by using the respective block body private key of the at least one second block-chain network; and send the at least one second block-chain data to the platform of processing the block-chain data.

According to embodiments of the present disclosure, the private key data stored by the target node is string data.

According to embodiments of the present disclosure, the distributed private key network 506 is used to: for each target node, obtain a concatenation order information and target string data based on the private key data stored by the target node; concatenate respective target string data of the at least one target node to obtain a target block body private key based on respective concatenation order information of the at least one target node; and segment the target block body private key based on a predetermined character length of the block body private key, so as to obtain the respective block body private key of the at least one second block-chain network.

According to embodiments of the present disclosure, when storing at least one block body private key belonging to the same requester, the distributed private key network may firstly concatenate the at least one block body private key to obtain a target block body private key, or further encrypt the concatenated at least one block body private key to obtain the target block body private key. It is possible to segment the target block body private key into a plurality of parts, determine a corresponding number of target nodes from the plurality of distributed nodes according to the number of parts, and generate a string parameter having the same size as the target block body private key in each target node. A parameter value of the string parameter may be empty. When storing and allocating the target block body private key, it is possible to replace, based on a position of each part of segmented target block body private key in the original block body private key, an element at a corresponding position in the string parameter of the target node, to obtain the private key data, thereby storing that part of target block body private key at the target node.

According to embodiments of the present disclosure, when obtaining the block body private key, for each target node, the distributed private key network may obtain the concatenation order information and the target string data based on the private key data stored by the target node. Specifically, the concatenation order information may be obtained based on a position of non-empty string data in each private key data. The target string data may be the non-empty string data in the private key data.

According to embodiments of the present disclosure, the distributed private key network may concatenate respective target string data of the at least one target node based on the respective concatenation order information of the at least one target node, so as to obtain the target block body private key.

According to embodiments of the present disclosure, since the at least one block body private key may be generated using an encryption algorithm with the same number of bits, the target block body private key may be segmented based on a predetermined character length of the block body private key to obtain the respective block body private key of the at least one block-chain network.

According to embodiments of the present disclosure, the at least one block body private key may have different numbers of bits. In a process of generating the target block body private key, it is possible to record the concatenation order and the number of digits of each block body private key, and segment the target block body private key based on the record.

According to embodiments of the present disclosure, the private key data stored by the target node may be curve coordinate data.

According to embodiments of the present disclosure, the distributed private key network 306 is used to: perform a curve fitting on the private key data respectively stored by the at least one target node based on a curve template, so as to obtain a target curve; concatenate a plurality of parameter values contained in the target curve, so as to obtain the target block body private key; and segment the target block body private key based on a predetermined character length of the block body private key, so as to obtain the respective block body private key of the at least one second block-chain network.

According to embodiments of the present disclosure, when storing at least one block body private key belonging to the same requester, the distributed private key network may firstly concatenate the at least one block body private key and further process the concatenated at least one block body private key into an integer value. It is possible to select a curve template according to the number of digits of the integer value, split the integer value into a plurality of parameter values according to a specified number of digits of each parameter in the curve template, and assign the plurality of parameter values to each parameter of the curve template, so as to obtain a target curve. For example, the integer value may be 12345678, the selected curve template may be represented as y=ax²+bx²+cx+d, and the specified number of digits for each parameter may be two digits, then the parameters of the curve template may be assigned as a=12, b=34, c=56, and d=78 respectively. After the assignment is completed, the obtained target curve may be expressed as y=12x²+23x²+56x+78. After the target curve is determined, it is possible to randomly select a plurality of coordinate points from the target curve, and the number of selected coordinate points may be greater than or equal to the number of parameters in the curve template. Based on the number of coordinate points, a corresponding number of target nodes may be selected from the plurality of distributed nodes, and the curve coordinate data of the plurality of coordinate points may be written to the target nodes.

According to embodiments of the present disclosure, when obtaining the block body private key, the distributed private key network may perform, based on the curve template, a curve fitting on the private key data stored by the at least one target node, so as to obtain the target curve. A plurality of parameter values contained in the target curve may be concatenated together to obtain the target block body private key. The target block body private key may be segmented based on the predetermined character length of the block body private key, so as to obtain respective block body private key of the at least one block-chain network.

According to embodiments of the present disclosure, the method of storing the block body private key in a distributed manner using distributed nodes may avoid a single-point risk of information storage, which helps to ensure the privacy and security of the block body private key of the user, and thus indirectly protect the privacy and security of the block-chain data of the user.

According to embodiments of the present disclosure, the first client device, the first block-chain network, the at least one second block-chain network, the platform of processing the block-chain data and the distributed private key network included in the system of processing the block-chain data may be used to perform the method of processing the block-chain data described in embodiments of the present disclosure. Reference may be made to the description of the corresponding part above, and will not be repeated herein.

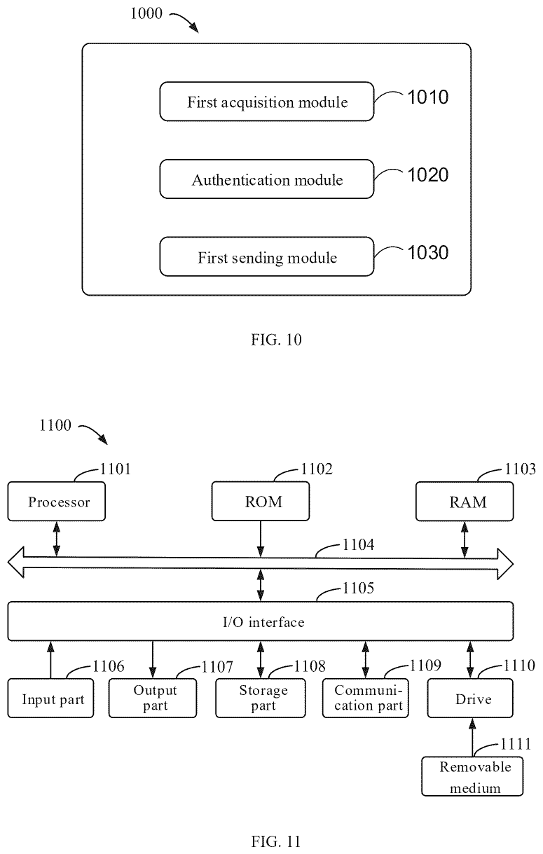

FIG. 10 schematically shows a block diagram of an apparatus of processing block-chain data according to embodiments of the present disclosure.

As shown in FIG. 10, an apparatus 1000 of processing block-chain data may include a first acquisition module 1010, an authentication module 1020, and a first sending module 1030.

The first acquisition module 1010 is used to acquire, in response to receiving a data processing request from a first client device, at least one first block-chain data from a first block-chain network based on an object identification information carried by the data processing request.

The authentication module 1020 is used to authenticate the first client device based on an encrypted verification information carried by the data processing request.

The first sending module 1030 is used to send the at least one first block-chain data to the first client device in response to determining that an authentication of the first client device is completed, so that the first client device decrypts the at least one first block-chain data to obtain at least one second block-chain data by using at least one block body private key respectively corresponding to the at least one first block-chain data.

According to embodiments of the present disclosure, the encrypted verification information is obtained by the first client device digitally signing a private key digest information using an object private key, and the private key digest information is obtained by the first client device concatenating and hashing the at least one block body private key respectively corresponding to the at least one first block-chain data.

According to embodiments of the present disclosure, the authentication module 1020 includes a first authentication unit, a second authentication unit, and a third authentication unit.

The first authentication unit is used to obtain an object public key based on the object identification information, where the object public key corresponds to the object private key.

The second authentication unit is used to verify the encrypted verification information using the object public key to obtain a first digest information, where the first digest information is the private key digest information if the encrypted verification information is verified successfully.

The third authentication unit is used to send the object identification information and the first digest information to a distributed private key network, so that the distributed private key network determines at least one block body private key according to the object identification information, concatenate and hash the at least one block body private key to obtain a second digest information, and determine an authentication result of the first client device based on a matching result of the first digest information and the second digest information.

According to embodiments of the present disclosure, the apparatus 1000 of processing the block-chain data further includes a second acquisition module.

The second acquisition module is used to perform, in response to the data processing request, a cross-chain data acquisition on at least one second block-chain network to obtain the at least one first block-chain data based on the object identification information, in a case of failing to acquire the at least one first block-chain data from the first block-chain network.

According to embodiments of the present disclosure, the second acquisition module includes a first acquisition unit and a second acquisition unit.

The first acquisition unit is used to: for each of the at least one second block-chain network, determine a cross-chain node of the second block-chain network.

The second acquisition unit is used to acquire the first block-chain data through the cross-chain node based on a node type of the cross-chain node.

According to embodiments of the present disclosure, the second acquisition unit includes a first acquisition sub-unit.

The first acquisition sub-unit is used to send, in response to determining that the cross-chain node is a full node, a data acquisition request containing the object identification information to the cross-chain node, so as to obtain the first block-chain data based on first feedback data returned by the cross-chain node. The first feedback data is obtained by the cross-chain node from a ledger of the cross-chain node based on the object identification information.

According to embodiments of the present disclosure, the second acquisition unit includes a second acquisition sub-unit.

The second acquisition sub-unit is used to send, in response to determining that the cross-chain node is a light node, a data acquisition request containing the object identification information to a full node of the second block-chain network through the cross-chain node, so as to obtain the first block-chain data based on second feedback data returned by the full node through the cross-chain node. The second feedback data is obtained by the full node from a ledger of the full node based on the object identification information forwarded by the cross-chain node.

According to embodiments of the present disclosure, the second acquisition module includes a third acquisition unit and a fourth acquisition unit.

The third acquisition unit is used to: for each of the at least one second block-chain network, broadcast a data acquisition request containing the object identification information to a plurality of block-chain nodes contained in the second block-chain network, in response to the second block-chain network being a public block-chain network.

The fourth acquisition unit is used to obtain the first block-chain data based on third feedback data respectively returned by the plurality of block-chain nodes. The third feedback data is obtained by the block-chain node from a ledger of the block-chain node based on the object identification information.

According to embodiments of the present disclosure, the encrypted verification information is obtained by the first client device digitally signing a verification information plaintext using an object private key, and the verification information plaintext is obtained by the first client device hashing an encrypted combination information.

According to embodiments of the present disclosure, the authentication module 1020 includes a fourth authentication unit, a fifth authentication unit, a sixth authentication unit, and a seventh authentication unit.

The fourth authentication unit is used to obtain a reserved encrypted combination information and an object public key based on the object identification information, where the object public key corresponds to the object private key.

The fifth authentication unit is used to verify the encrypted verification information using the object public key to obtain a first verification information, where the first verification information is the verification information plaintext in response to determining that the encrypted verification information being verified successfully.

The sixth authentication unit is used to hash the reserved encrypted combination information to obtain a second verification information.

The seventh authentication unit is used to determine an authentication result of the first client device based on a matching result of the first verification information and the second verification information.

According to embodiments of the present disclosure, the encrypted combination information or the reserved encrypted combination information includes at least one selected from: an answer text for a predetermined question, a password string, or a biometric information.

According to embodiments of the present disclosure, the apparatus 1000 of processing the block-chain data further includes a second sending module.

The second sending module is used to send the object identification information and the at least one first block-chain data to a distributed private key network in response to determining that an authentication of the first client device is completed, so that the distributed private key network decrypts the at least one first block-chain data to obtain at least one second block-chain data based on the object identification information by using respective block body private key of the at least one second block-chain network.

According to embodiments of the present disclosure, the apparatus 1000 of processing the block-chain data further includes a first processing module, a first encryption module, a first writing module, and a third sending module.

The first processing module is used to: for each of the at least one second block-chain network, perform a text normalization on second block-chain data of the second block-chain network to obtain first normalized data.

The first encryption module is used to encrypt the first normalized data to obtain second normalized data by using a block body public key corresponding to the second block-chain network, where the block body public key corresponds to the block body private key.

The first writing module is used to write the second normalized data into a memory.

The third sending module is used to send respective second normalized data of the at least one second block-chain network to the first client device in response to detecting that the first client device accesses the memory through a predetermined interface, where the first client device is used to decrypt, for each of the at least one second block-chain network, the second normalized data of the second block-chain network to obtain the first normalized data by using a block body private key corresponding to the second block-chain network, and render and display the first normalized data on a display interface of the first client device.

According to embodiments of the present disclosure, the apparatus 1000 of processing the block-chain data further includes a first adding module.

The first adding module is used to add the at least one first block-chain data to the first block-chain network in response to the at least one first block-chain data being obtained by performing the cross-chain acquisition on the at least one second block-chain network.

According to embodiments of the present disclosure, the apparatus 1000 of processing the block-chain data further includes a second writing module and a fourth sending module.

The second writing module is used to write the at least one first block-chain data into a memory.

The fourth sending module is used to send the at least one first block-chain data to the first client device in response to detecting that the first client device accesses the memory through a predetermined interface, where the first client device is configured to decrypt the at least one first block-chain data to obtain at least one second block-chain data by using at least one block body private key respectively corresponding to the at least one first block-chain data, call a text classification service to normalize the at least one second block-chain data to obtain at least one first normalized data, and render and display the at least one first normalized data on a display interface of the first client device.

According to embodiments of the present disclosure, the apparatus 1000 of processing the block-chain data further includes a third acquisition module, a second processing module, a second encryption module, and a second adding module.

The third acquisition module is used to acquire, in response to a data sharing request from the first client device, first target block-chain data carried by the data sharing request.

The second processing module is used to perform a text normalization on the first target block-chain data to obtain third normalized data.

The second encryption module is used to encrypt the third normalized data to obtain fourth normalized data.

The second adding module is used to add the fourth normalized data to a third block-chain network.

According to embodiments of the present disclosure, the apparatus 1000 of processing the block-chain data further includes a determination module, a third processing module, and a fifth sending module.

The determination module is used to determine, in response to a data call request from a second client device, a data call model based on a call type information carried by the data call request.

The third processing module is used to process fourth block-chain data contained in the third block-chain network to obtain second target block-chain data by using the data call model, where the fourth block-chain data includes the fourth normalized data.

The fifth sending module is used to decrypt the second target block-chain data, and send decrypted second target block-chain data to the second client device.

Any number of the modules, sub-modules, units and sub-units according to embodiments of the present disclosure, or at least part of functions of any number of them may be implemented in one module. Any one or more of the modules, sub-modules, units and sub-units according to embodiments of the present disclosure may be split into a plurality of modules for implementation. Any one or more of the modules, sub-modules, units and sub-units according to embodiments of the present disclosure may be implemented at least partially as a hardware circuit, such as a field programmable gate array (FPGA), a programmable logic array (PLA), a system on a chip, a system on a substrate, a system on a package, an Application Specific Integrated Circuit (ASIC), or may be implemented by hardware or firmware in any other reasonable manner of integrating or encapsulating the circuit, or may be implemented by any one of three implementation modes of software, hardware and firmware or an appropriate combination thereof. Alternatively, one or more of the modules, sub-modules, units and sub-units according to embodiments of the present disclosure may be at least partially implemented as a computer program module that, when executed, performs the corresponding functions.

For example, any number of the first acquisition module 1010, the authentication module 1020 and the first sending module 1030 may be combined into one module/unit/sub-unit for implementation, or any one of the modules/units/sub-units may be divided into a plurality of modules/units/sub-units. Alternatively, at least part of the functions of one or more of these modules/units/sub-units may be combined with at least part of the functions of other modules/units/sub-units and implemented in one module/unit/sub-unit. According to embodiments of the present disclosure, at least one of the first acquisition module 1010, the authentication module 1020 and the first sending module 1030 may be implemented at least partially as a hardware circuit, such as a field programmable gate array (FPGA), a programmable logic array (PLA), a system on a chip, a system on a substrate, a system on a package, an Application Specific Integrated Circuit (ASIC), or may be implemented by hardware or firmware in any other reasonable manner of integrating or encapsulating the circuit, or may be implemented by any one of the three implementation modes of software, hardware and firmware or an appropriate combination thereof. Alternatively, at least one of the first acquisition module 1010, the authentication module 1020 and the first sending module 1030 may be at least partially implemented as a computer program module that may perform corresponding functions when executed.

It should be noted that a part for the apparatus of processing the block-chain data in embodiments of the present disclosure corresponds to a part for the method of processing the block-chain data in embodiments of the present disclosure. For the descriptions of the apparatus of processing the block-chain data, reference may be made to the method of processing the block-chain data, and details will not be repeated here.

FIG. 11 schematically shows a block diagram of an electronic device suitable for implementing the method of processing the block-chain data according to embodiments of the present disclosure. The electronic device shown in FIG. 11 is just an example, and should not bring any limitation to functions and scopes of use of embodiments of the present disclosure.

As shown in FIG. 11, an electronic device 1100 according to embodiments of the present disclosure includes a processor 1101, which may execute various appropriate actions and processing according to the program stored in a read only memory (ROM) 1102 or the program loaded into a random access memory (RAM) 1103 from a storage part 1108. The processor 1101 may, for example, include a general-purpose microprocessor (for example, CPU), an instruction set processor and/or a related chipset and/or a special-purpose microprocessor (for example, an application specific integrated circuit (ASIC)), and the like. The processor 1101 may further include an on-board memory for caching purposes. The processor 1101 may include a single processing unit or multiple processing units for executing different actions of the method flow according to embodiments of the present disclosure.

Various programs and data required for the operation of the device 1100 are stored in the RAM 1103. The processor 1101, the ROM 1102 and the RAM 1103 are connected to each other through a bus 1104. The processor 1101 executes various operations of the method flow according to embodiments of the present disclosure by executing the programs in the ROM 1102 and/or the RAM 1103. It should be noted that the program may also be stored in one or more memories other than the ROM 1102 and the RAM 1103. The processor 1101 may also execute various operations of the method flow according to embodiments of the present disclosure by executing the programs stored in the one or more memories.

According to embodiments of the present disclosure, the electronic device 1100 may further include an input/output (I/O) interface 1105 which is also connected to the bus 1104. The device 1100 may further include one or more of the following components connected to the I/O interface 1105: an input part 1106 including a keyboard, a mouse, etc.; an output part 1107 including a cathode ray tube (CRT), a liquid crystal display (LCD), etc. and a speaker, etc.; a storage part 1108 including a hard disk, etc.; and a communication part 1109 including a network interface card such as a LAN card, a modem, and the like. The communication part 1109 performs communication processing via a network such as the Internet. A drive 1110 is also connected to the I/O interface 1105 as required. A removable medium 1111, such as a magnetic disk, an optical disk, a magneto-optical disk, a semiconductor memory, and the like, is installed on the drive 1110 as required, so that the computer program read therefrom is installed into the storage part 1108 as needed.

The method flow according to embodiments of the present disclosure may be implemented as a computer software program. For example, embodiments of the present disclosure include a computer program product including a computer program carried on a computer-readable storage medium. The computer program includes a program code for execution of the method shown in the flowchart. In such embodiments, the computer program may be downloaded and installed from the network through the communication part 1109, and/or installed from the removable medium 1111. When the computer program is executed by the processor 1101, the above-mentioned functions defined in the system of embodiments of the present disclosure are performed. According to embodiments of the present disclosure, the above-described systems, apparatuses, devices, modules, units, etc. may be implemented by computer program modules.

The present disclosure further provides a computer-readable storage medium, which may be included in the apparatus/device/system described in the above embodiments; or exist alone without being assembled into the apparatus/device/system. The above-mentioned computer-readable storage medium carries one or more programs that when executed, perform the methods according to embodiments of the present disclosure.

According to embodiments of the present disclosure, the computer-readable storage medium may be a non-transitory computer-readable storage medium, for example, may include but not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination of the above. In the present disclosure, the computer-readable storage medium may be any tangible medium that contains or stores programs that may be used by or in combination with an instruction execution system, apparatus or device.

For example, according to embodiments of the present disclosure, the computer-readable storage medium may include the above-mentioned ROM 1102 and/or RAM 1103 and/or one or more memories other than the ROM 1102 and RAM 1103.

Embodiments of the present disclosure further include a computer program product, which contains a computer program. The computer program contains program code for performing the method provided by the embodiments of the present disclosure. When the computer program product runs on an electronic device, the program code causes the electronic device to implement the method of processing the block-chain data provided in embodiments of the present disclosure.

When the computer program is executed by the processor 1101, the above-mentioned functions defined in the system/apparatus of the embodiments of the present disclosure are performed. According to the embodiments of the present disclosure, the above-described systems, apparatuses, modules, units, etc. may be implemented by computer program modules.

In an embodiment, the computer program may rely on a tangible storage medium such as an optical storage device and a magnetic storage device. In another embodiment, the computer program may also be transmitted and distributed in the form of signals on a network medium, downloaded and installed through the communication part 1109, and/or installed from the removable medium 1111. The program code contained in the computer program may be transmitted by any suitable medium, including but not limited to a wireless one, a wired one, or any suitable combination of the above.

According to the embodiments of the present disclosure, the program code for executing the computer programs provided by the embodiments of the present disclosure may be written in any combination of one or more programming languages. In particular, these computing programs may be implemented using high-level procedures and/or object-oriented programming languages, and/or assembly/machine languages. Programming languages include, but are not limited to, Java, C++, Python, “C” language or similar programming languages. The program code may be completely executed on the user computing device, partially executed on the user device, partially executed on the remote computing device, or completely executed on the remote computing device or server. In a case of involving a remote computing device, the remote computing device may be connected to a user computing device through any kind of network, including a local area network (LAN) or a wide area networks (WAN), or may be connected to an external computing device (e.g., through the Internet using an Internet service provider).

The flowcharts and block diagrams in the accompanying drawings illustrate the possible architecture, functions, and operations of the system, method, and computer program product according to various embodiments of the present disclosure. In this regard, each block in the flowcharts or block diagrams may represent a part of a module, a program segment, or a code, which part includes one or more executable instructions for implementing the specified logical function. It should be further noted that, in some alternative implementations, the functions noted in the blocks may also occur in a different order from that noted in the accompanying drawings. For example, two blocks shown in succession may actually be executed substantially in parallel, or they may sometimes be executed in a reverse order, depending on the functions involved. It should be further noted that each block in the block diagrams or flowcharts, and the combination of blocks in the block diagrams or flowcharts, may be implemented by a dedicated hardware-based system that performs the specified functions or operations, or may be implemented by a combination of dedicated hardware and computer instructions. Those skilled in the art may understand that the various embodiments of the present disclosure and/or the features described in the claims may be combined in various ways, even if such combinations are not explicitly described in the present disclosure. In particular, without departing from the spirit and teachings of the present disclosure, the various embodiments of the present disclosure and/or the features described in the claims may be combined in various ways. All these combinations fall within the scope of the present disclosure.

Embodiments of the present disclosure have been described above. However, these embodiments are just for illustrative purposes and are not intended to limit the scope of the present disclosure. Although various embodiments have been described separately above, this does not mean that measures in the embodiments may not be used in combination advantageously. The scope of the present disclosure is defined by the appended claims and their equivalents. Those skilled in the art may make various substitutions and modifications without departing from the scope of the present disclosure, and these substitutions and modifications should all fall within the scope of the present disclosure.

1. A method of processing block-chain data, comprising:
acquiring, in response to receiving a data processing request from a first client device, at least one first block-chain data from a first block-chain network based on an object identification information carried by the data processing request;
authenticating the first client device based on an encrypted verification information carried by the data processing request; and
sending the at least one first block-chain data to the first client device in response to determining that an authentication of the first client device is completed, so that the first client device decrypts the at least one first block-chain data to obtain at least one second block-chain data by using at least one block body private key respectively corresponding to the at least one first block-chain data.

2. The method according to claim 1, wherein the encrypted verification information is obtained by the first client device digitally signing a private key digest information using an object private key, and the private key digest information is obtained by the first client device concatenating and hashing the at least one block body private key respectively corresponding to the at least one first block-chain data; and
wherein the authenticating the first client device based on an encrypted verification information carried by the data processing request comprises:
obtaining an object public key based on the object identification information, wherein the object public key corresponds to the object private key;
verifying the encrypted verification information using the object public key to obtain a first digest information, wherein the first digest information is the private key digest information in response to the encrypted verification information being verified successfully; and
sending the object identification information and the first digest information to a distributed private key network, so that the distributed private key network determines at least one block body private key according to the object identification information, concatenates and hashes the at least one block body private key to obtain a second digest information, and determines an authentication result of the first client device based on a matching result of the first digest information and the second digest information.

3. The method according to claim 1, further comprising:
performing, in response to the data processing request, a cross-chain data acquisition on at least one second block-chain network to obtain the at least one first block-chain data based on the object identification information, in a case of failing to acquire the at least one first block-chain data from the first block-chain network.

4. The method according to claim 3, wherein the performing a cross-chain data acquisition on at least one second block-chain network to obtain the at least one first block-chain data based on the object identification information comprises: for each of the at least one second block-chain network,
determining a cross-chain node of the second block-chain network; and
acquiring the first block-chain data through the cross-chain node based on a node type of the cross-chain node.

5. The method according to claim 4, wherein the acquiring the first block-chain data through the cross-chain node based on a node type of the cross-chain node comprises:
sending, in response to determining that the cross-chain node is a full node, a data acquisition request containing the object identification information to the cross-chain node, so as to obtain the first block-chain data based on first feedback data returned by the cross-chain node;
wherein the first feedback data is obtained by the cross-chain node from a ledger of the cross-chain node based on the object identification information.

6. The method according to claim 4, wherein the acquiring the first block-chain data through the cross-chain node based on a node type of the cross-chain node comprises:
sending, in response to determining that the cross-chain node is a light node, a data acquisition request containing the object identification information to a full node of the second block-chain network through the cross-chain node, so as to obtain the first block-chain data based on second feedback data returned by the full node through the cross-chain node;
wherein the second feedback data is obtained by the full node from a ledger of the full node based on the object identification information forwarded by the cross-chain node.

7. The method according to claim 3, wherein the performing a cross-chain data acquisition on at least one second block-chain network to obtain the at least one first block-chain data based on the object identification information comprises: for each of the at least one second block-chain network,
broadcasting a data acquisition request containing the object identification information to a plurality of block-chain nodes contained in the second block-chain network, in response to the second block-chain network being a public block-chain network; and
obtaining the first block-chain data based on third feedback data respectively returned by the plurality of block-chain nodes, wherein the third feedback data is obtained by the block-chain node from a ledger of the block-chain node based on the object identification information.

8. The method according to claim 3, wherein the encrypted verification information is obtained by the first client device digitally signing a verification information plaintext using an object private key, and the verification information plaintext is obtained by the first client device hashing an encrypted combination information; and
wherein the authenticating the first client device based on an encrypted verification information carried by the data processing request comprises:
obtaining a reserved encrypted combination information and an object public key based on the object identification information, wherein the object public key corresponds to the object private key;
verifying the encrypted verification information using the object public key to obtain a first verification information, wherein the first verification information is the verification information plaintext in response to determining that the encrypted verification information being verified successfully;
hashing the reserved encrypted combination information to obtain a second verification information; and
determining an authentication result of the first client device based on a matching result of the first verification information and the second verification information.

9. The method according to claim 8, wherein the encrypted combination information or the reserved encrypted combination information comprises at least one selected from the group consisting of:
an answer text for a predetermined question, a password string, and a biometric information.

10. The method according to claim 1, further comprising:
sending the object identification information and the at least one first block-chain data to a distributed private key network in response to determining that an authentication of the first client device is completed, so that the distributed private key network decrypts the at least one first block-chain data to obtain at least one second block-chain data based on the object identification information by using a respective block body private key of the at least one second block-chain network.

11. The method according to claim 10, further comprising: for each of the at least one second block-chain network,
performing a text normalization on second block-chain data of the second block-chain network to obtain first normalized data;
encrypting the first normalized data to obtain second normalized data by using a block body public key corresponding to the second block-chain network, wherein the block body public key corresponds to the block body private key;
writing the second normalized data into a memory; and
sending respective second normalized data of the at least one second block-chain network to the first client device in response to detecting that the first client device accesses the memory through a predetermined interface, wherein the first client device is configured to decrypt, for each of the at least one second block-chain network, the second normalized data of the second block-chain network to obtain the first normalized data by using a block body private key corresponding to the second block-chain network, and render and display the first normalized data on a display interface of the first client device.

12. The method according to claim 3, further comprising:
adding the at least one first block-chain data to the first block-chain network in response to the at least one first block-chain data being obtained by performing the cross-chain data acquisition on the at least one second block-chain network.

13. The method according to claim 1, further comprising:
writing the at least one first block-chain data into a memory; and
sending the at least one first block-chain data to the first client device in response to detecting that the first client device accesses the memory through a predetermined interface, wherein the first client device is configured to decrypt the at least one first block-chain data to obtain at least one second block-chain data by using at least one block body private key respectively corresponding to the at least one first block-chain data, call a text classification service to normalize the at least one second block-chain data to obtain at least one first normalized data, and render and display the at least one first normalized data on a display interface of the first client device.

14. The method according to claim 1, further comprising:
acquiring, in response to a data sharing request from the first client device, first target block-chain data carried by the data sharing request;
performing a text normalization on the first target block-chain data to obtain third normalized data;
encrypting the third normalized data to obtain fourth normalized data; and
adding the fourth normalized data to a third block-chain network.

15. The method according to claim 14, further comprising:
determining, in response to a data call request from a second client device, a data call model based on a call type information carried by the data call request;
processing fourth block-chain data contained in the third block-chain network to obtain second target block-chain data by using the data call model, wherein the fourth block-chain data comprises the fourth normalized data; and
decrypting the second target block-chain data, and sending decrypted second target block-chain data to the second client device.

16-30. (canceled)

31. A system of processing block-chain data, comprising:
a first client device, a first block-chain network, a platform of processing the block-chain data, and a distributed private key network;
wherein the platform of processing the block-chain data is configured to:
acquire, in response to receiving a data processing request from a first client device, at least one first block-chain data from a first block-chain network based on an object identification information carried by the data processing request;
authenticate the first client device based on an encrypted verification information carried by the data processing request; and
send the at least one first block-chain data to the first client device in response to determining that an authentication of the first client device is completed; and
wherein the first client device is configured to:
decrypt the at least one first block-chain data to obtain at least one second block-chain data by using at least one block body private key respectively corresponding to the at least one first block-chain data.

32. The system according to claim 31, further comprising:
at least one second block-chain network, wherein the platform of processing the block-chain data is configured to:
perform, in response to the data processing request, a cross-chain data acquisition on at least one second block-chain network to obtain the at least one first block-chain data based on the object identification information, in a case of failing to acquire the at least one first block-chain data from the first block-chain network,
wherein the platform of processing the block-chain data is configured to:
send the object identification information and the at least one first block-chain data to a distributed private key network in response to determining that an authentication of the first client device is completed;
wherein the distributed private key network is configured to:
decrypt the at least one first block-chain data to obtain at least one second block-chain data based on the object identification information by using respective block body private key of the at least one second block-chain network, and
wherein the distributed private key network is configured to:
determine, in response to receiving the object identification information and the at least one first block-chain data from the platform of processing the block-chain data, at least one target node from a plurality of distributed nodes based on the object identification information;
obtain a respective block body private key of the at least one second block-chain network based on private key data respectively stored by the at least one target node;
decrypt the at least one first block-chain data to obtain at least one second block-chain data by using the respective block body private key of the at least one second block-chain network; and
send the at least one second block-chain data to the platform of processing the block-chain data.

33-34. (canceled)

35. The system according to claim 32, wherein the private key data stored by the target node is string data; and
wherein the distributed private key network is configured to: for each target node,
obtain a concatenation order information and target string data based on the private key data stored by the target node;
concatenate respective target string data of the at least one target node to obtain a target block body private key based on respective concatenation order information of the at least one target node; and
segment the target block body private key based on a predetermined character length of the block body private key, so as to obtain the respective block body private key of the at least one second block-chain network, or
wherein the private key data stored by the target node is curve coordinate data; and
wherein the distributed private key network is configured to:
perform a curve fitting on the private key data respectively stored by the at least one target node based on a curve template, so as to obtain a target curve;
concatenate a plurality of parameter values contained in the target curve, so as to obtain the target block body private key; and
segment the target block body private key based on a predetermined character length of the block body private key, so as to obtain the respective block body private key of the at least one second block-chain network.

36-37. (canceled)

38. An electronic device, comprising a memory and a processor, wherein the memory stores instructions executable by the processor, and the instructions are configured to, when executed by the processor, cause the processor to implement the method of claim 1.

39. A non-instantaneous computer-readable storage medium having computer instructions stored thereon, wherein the computer instructions are configured to cause a computer to implement the method of claim 1.

40. (canceled)
